(19) United States
(12) Patent Application Publication
(10) Pub. No.: US 2025/0106800 A1
(43) Pub. Date: Mar. 27, 2025

(54) SYSTEMS AND METHODS FOR USING REPLACEMENT NETWORK SLICES

(71) Applicant: Verizon Patent and Licensing Inc., Basking Ridge, NJ (US)

(72) Inventors: Suzann Hua, Beverly Hills, CA (US); Helen Osias Eglip, Sammamish, WA (US); Shanthala Kuravangi-Thammaiah, Keller, TX (US); Jerry Steben, Fort Worth, TX (US)

(21) Appl. No.: 18/475,851

(22) Filed: Sep. 27, 2023

(51) Int. Cl. H04W 60/00; H04W 48/16; H04W 48/18

(52) U.S. Cl. CPC H04W 60/00; H04W 48/16; H04W 48/18

(57) ABSTRACT

A device may include a processor. The processor may be configured to receive, from the User Equipment device (UE), over a network, a registration request that includes a list of network slices requested by the UE; request a network component to provide a list of network slices to which the UE is subscribed; obtain a list of replacement network slices for replacing one or more of the list of network slices when one or more of the list of network slices become unavailable for a session with the UE; obtain a second list of network slices, which are allowed by the network to establish a session with the UE, based on the list of network slices and the list of replacement network slices; and send the second list of network slices to the UE.

### BACKGROUND INFORMATION

Wireless communication service providers continue to develop and expand available services and their networks to meet increasing consumer and technology driven demands for higher bandwidth and lower latency. For example, data-intensive applications like augmented reality (AR), cloud gaming, and video conferencing require both high bandwidths and low latency. To meet such requirements, next generation networks, such as Fifth Generation (5G) and Sixth Generation (6G) mobile networks, are incorporating a variety of technologies in their network.

### BRIEF DESCRIPTION OF THE DRAWINGS

FIG. 1 illustrates concepts described herein;

FIG. 2 illustrates an exemplary network environment in which systems and methods described herein may be implemented;

FIG. 3 depicts example components of a User Equipment device (UE) according to an implementation;

FIG. 4 illustrates a portion of a core network according to an implementation;

FIG. 5 illustrates example replacement Network Slice Selection Assistance Information (NSSAI) stored at a Unified Data Repository (UDR), according to an implementation;

FIG. 6 is a flow diagram of an exemplary process for providing a list of replacement network slices, according to an implementation;

FIG. 7 is a messaging diagram that is associated with a process for providing a list of replacement network slices, according to an implementation;

FIG. 8 is a flow diagram of an exemplary process for using a list of replacement network slices, according to an implementation;

FIG. 9 is a messaging diagram that is associated with a process for using a list of replacement network slices, according to an implementation; and

FIG. 10 depicts exemplary functional components of a network device according to an implementation.

### DETAILED DESCRIPTION

The following detailed description refers to the accompanying drawings. The same reference numbers in different drawings may identify the same or similar elements.

Systems and methods described herein relate to using network slices and/or replacement network slices. With a network replacement scheme, when a User Equipment device (UE) (e.g., a smart phone) requests a network to allow the UE to connect to a network slice and the network slice is congested or unavailable, the network may select a replacement or alternate network slice. The systems and methods described herein relate to selecting and using replacement network slices.

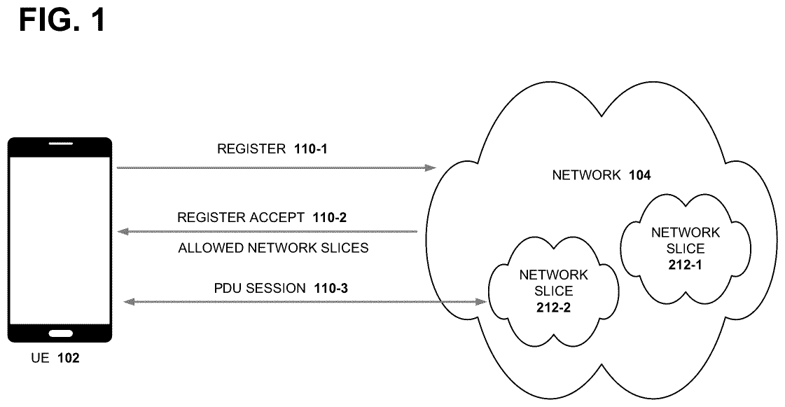

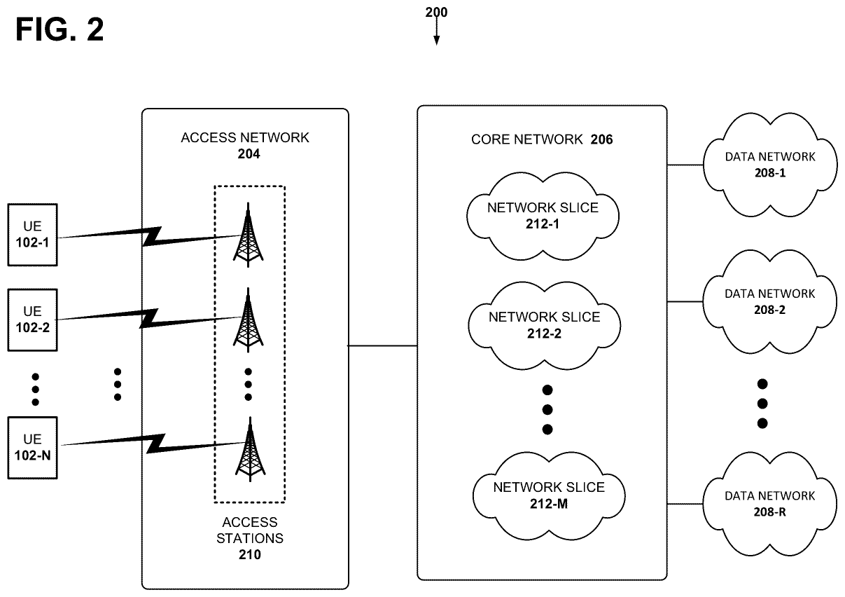

FIG. 1 illustrates the concepts described herein. As shown, a service provider network 104 (e.g., a cellular network) includes network slices 212-1 and 212-2 (to be described below in greater detail with reference to FIG. 2). Assume that the user of UE 102 has subscribed to network slice 212-1 to receive network services for a game application running on UE 102. In addition, assume that the user has also selected network slice 212-2 as a replacement for network slice 212-1, based on, for example, a comparable level of Quality of Service (QOS) (e.g., network slice 212-2 has as low a latency as network slice 212-1 or has a similar bandwidth). Network 104 stores data indicating the user selection of network slice 212-1 and its replacement network slice 212-2.

As further shown, when UE 102 registers with network 104 (arrow 110-1), UE 102 sends a list of requested network slices. The requested network slices may include network slice 212-1. Network 104 may then check its internal data to verify the list of requested network slices and its list of replacement network slices, which may include network slice 212-2. Network 104 may then generate a list of allowed network slices (e.g., network slices that UE 102 may access at UE 102's location), which include network slices 212-1 and 212-2. When network 104 completes the registration of UE 102, network 104 sends the list of allowed network slices to UE 102. Upon receipt of the allowed network slices, UE 102 may connect to any of the allowed network slices. For example, UE 102 may request a connection to network slice 212-1. If network 104 determines that network slice 212-1 is unavailable due to a network failure or network slice 212-1 is congested, network 104 may have UE 102 establish a Protocol Data Unit (PDU) session 110-3 with replacement network slice 212-2. In this manner, network 104 may provide an expected level of service to UE 102.

FIG. 2 illustrates an exemplary network environment 200 in which the systems and methods may be implemented. As shown, environment 200 may include UEs 102-1 through 102-N (collectively referred to as UEs 102 and generically referred to as UE 102), an access network 204, a core network 206, and data networks 208-1 through 208-R (collectively referred to as data networks 208 and generically referred to as data network 208). Access network 204, core network 206, and data networks 208 may be part of provider network 104 (not shown in FIG. 2).

UEs 102 may include wireless communication devices capable of 5G New Radio (NR) communication. Some UEs 102 may additionally include Fourth Generation (4G) (e.g., Long-Term Evolution (LTE)) communication capabilities or Sixth Generation (6G) communication capabilities. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; a Fixed Wireless Access (FWA) device; a Customer Premises Equipment (CPE) device, with or without Wi-Fi® capabilities; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices. UE 102 may include one or more components that permit UE 102 to recognize replacement network slices.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210 (herein generically referred to as access station 210) for establishing and maintaining over-the-air channel with UEs 102. In some implementations, access station 210 may include a 4G, 5G, 6G or another type of base station (e.g., eNB, gNB, etc.) that includes one or more radio frequency (RF) transceivers. In some implementations, access station 210 may be part of an evolved Universal Mobile Telecommunications Service (UMTS) Terrestrial Radio Access Network (eUTRAN).

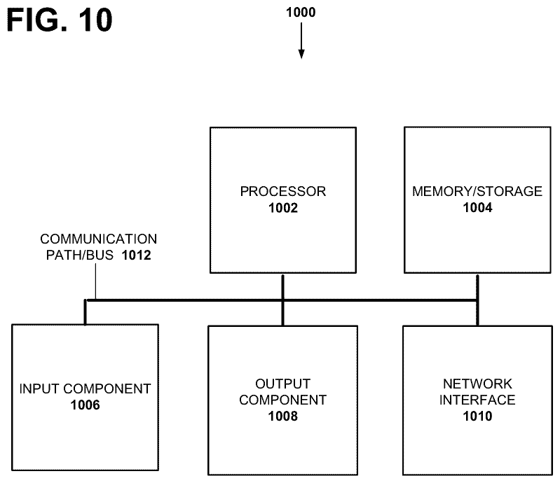

Core network 206 may manage communication sessions of UEs 102 connecting to core network 206 via access network 204. For example, core network 206 may establish an Internet Protocol (IP) connection between UEs 102 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven server-less architecture interface, and/or another type of SDN component. The common shared physical infrastructure may be implemented using one or more devices 1000 described below with reference to FIG. 10 in a cloud computing center associated with core network 206. Core network 206 may include 5G core network components, 4G core network components, and/or another type of core network components (e.g., 6G core network components). Some of 5G core network components that may include part of the system for selecting and using replacement network slices are described below with reference to FIG. 4.

As further shown, core network 206 may include one or more network slices 212-1 through 212-M (herein collectively referred to as network slices 212 and generically as network slice 212). Depending on the implementation, network slices 212 may be implemented within other networks, such as access network 204 and/or data network 208. Access network 204, core network 206, and data networks 208 may include multiple instances of network slices 212. Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular QoS class, a type of service, 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice may be associated with corresponding subscription data, stored in core network 206 for example, which includes the S-NSSAI corresponding to the network slice. NSSAI may refer to a set of S-NSSAIs or multiple S-NSSAIs that are not part of a set or group.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UE 102 and may establish communication sessions with UE 102 via core network 206.

For clarity, FIG. 2 does not show all components that may be included in network environment 200 (e.g., routers, bridges, wireless access point, additional networks, data centers, portals, etc.). Depending on the implementation, network environment 200 may include additional, fewer, different, or a different arrangement of components than those illustrated in FIG. 2. Furthermore, in different implementations, the configuration of network environment 200 may be different.

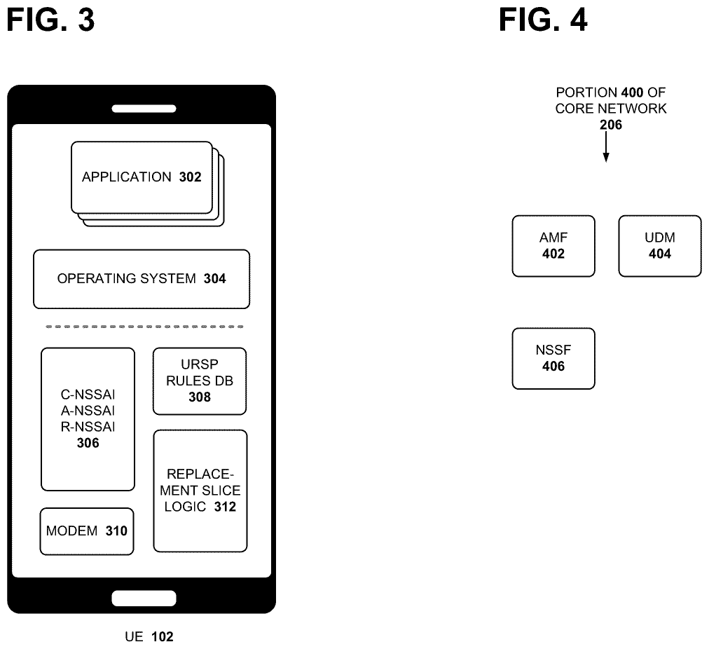

FIG. 3 depicts example components of UE 102 according to an implementation. As shown, UE 102 may include one or more of application 302, an operating system 304, NSSAI lists 306, UE Route Selection Policy (URSP) rules database (DB) 308, a modem 310, and replacement slice logic 312. Depending on the implementation, UE 102 may comprise other components or different components than those illustrated in FIG. 3.

Application 302 may include one or more software programs that run on UE 102. Application 302 may operate in conjunction with another program, also referred to as an application, in network 104, in network slice 212, or in data network 208. Application 302 may include or be associated with a traffic descriptor. A traffic descriptor may include an app ID, a fully qualified domain name (FQDN), a DNN, etc. A traffic descriptor may indicate a type of traffic that application 302 may exchange over a connection that it establishes with network slice 212 or data network 208 (e.g., a video stream, an audio stream, Internet traffic, etc.).

When application 302 initiates a connection to a network slice 212 or data network 208, application 302 may invoke a call to lower layers of the system in UE 102, through operating system 304, to modem 310. Once the connection is established with a component in network 104, application 302 may communicate with the component (e.g., send data or receive data) over the connection.

Operating system 304 may manage applications 302, services, memory, and/or other resources on UE 102. Additionally, as indicated above, operating system 304 may relay connection requests from application 302 to modem 310 and relay messages, whose destinations are one of applications 302 and which arrive at modem 310 from network 104 to application 302.

NSSAI lists 306 may include different types of NSSAI or S-NSSAIs. Although herein referred to as “NSSAI lists 306,” NSSAI lists 306 may not literally refer to lists but to NSSAI and S-NSSAIs stored in various parts of UE 102. More specifically, referring to FIG. 3, NSSAI lists 306 may include subscribed NSSAI (C-NSSAI) (also referred to as configured NSSAI), allowed NSSAI (A-NSSAI), and requested NSSAI (R-NSSAI). C-NSSAI may identify network slices to which the UE 102 is subscribed. C-NSSAI may include, for example, up to 16 S-NSSAIs, one of which includes a default S-NSSAI. A-NSSAI may include a set of S-NSSAIs that identify network slices 212 with which UE 102 may establish a PDU session. A-NSSAI may include a subset of S-NSSAIs included in the C-NSSAI. R-NSSAI may include a set of S-NSSAIs that UE 102 requests from network 104 for approval during its registration.

URSP rules DB 308 may include URSP rules. Each URSP rule in URSP rule DB 308 may include a traffic descriptor and one or more rule descriptors. When a URSP rule is applied based on matching a traffic descriptor included in a connection request from application 302 to a traffic descriptor in the URSP rule, one of the rule descriptors may identify a network slice 212 (i.e., a S-NSSAI). When network 104 sends updated URSP rules to UE 102, modem 310 may store the updated URSP rules in URSP rules DB 308. Furthermore, modem 310 may access URSP rules DB 308 when modem 310 has to look up a URSP rule whose traffic descriptor matches the traffic descriptor in the connection request received by modem 310 from application 302 via operating system 304.

Modem 310 may perform communication-related functions, including establishing connections and/or sessions between UE 102 and network 104, delivering messages from/to UE 102 to/from network 104, perform modulation/demodulation, perform signal processing, etc. When modem 310 receives a connection request from applications 302 via operating system 304, modem 310 may extract a traffic descriptor from the request. Next, modem 310 may apply a URSP rule that matches the traffic descriptor to identify the network slice 212 or data network 208 to which the connection is to be established from the application 302. Thereafter, modem 310 may establish the connection to the identified network slice 212 or the identified data network 208.

Replacement slice logic 312 may include a program and/or hardware component for having UE 102 identify and use replacement network slices. For example, if UE 102 receives the NSSAI for replacement network slices (replacement NSSAI) from the MNO of network 104, UE 102 may store the replacement NSSAI. In other implementations, if UE 102 does not receive replacement NSSAI, replacement slice logic 312 may determine replacement NSSAI based on the C-NSSAI, the A-NSSAI, and/or the replacement S-NSSAI that network 104 provides to UE 102 when UE 102 requests a PDU connection. For example, when core network 206 sends the A-NSSAI to UE 102, replacement slice logic 312 may compare its C-NSSAI to the A-NSSAI. If each S-NSSAI in A-NSSAI does not appear in the C-NSSAI, replacement slice logic 312 may determine that the S-NSSAI is a replacement S-NSSAI.

Replacement slice logic 312 may also permit UE 102 to connect to a replacement network slice when UE 102 sends a request to establish a PDU session to network 104, designating a particular S-NSSAI. When network 104 determines that the designated network slice is not available and returns a replacement S-NSSAI, replacement slice logic 312 may verify the replacement S-NSSAI based on the A-NSSAI and the C-NSSAI. If the replacement S-NSSAI is verified, replacement slice logic 312 may permit modem 310 to establish the PDU session with the network slice identified by the replacement S-NSSAI. If replacement slice logic 312 cannot verify the replacement S-NSSAI, replacement slice logic 312 may alert the user or network 104 that an incorrect replacement S-NSSAI was received by UE 102.

FIG. 4 illustrates a portion of core network 206, according to an implementation. As shown, portion 400 of core network 206 may include an Access and Mobility Management Function (AMF) 402, a Unified Data Management and/or a Unified Data Repository (collectively herein referred to as UDM 404), and a Network Slice Selection Function (NSSF) 406. Each of components 402-406 may include one or more network devices 1000 (FIG. 10) or be implemented via one or more network devices 1000. Depending on the implementation, portion 400 may include additional, fewer, and/or different 5G core network components than those illustrated in FIG. 4.

AMF 402 may perform registration management, connection management, reachability management, mobility management, lawful intercepts, Short Message Service (SMS) transport between UE 102 and a Short Message Service Function (SMSF), session management messages transport between UE 102 and a Session Management Function (SMF), access authentication and authorization, location services management, functionality to support non-3GPP access networks, and/or other types of management.

AMF 402 may be configured to support selecting and using replacement NSSAIs in many ways. For example, when UE 102 initiates a registration with AMF 402, sending R-NSSAI along with the registration request, AMF 402 may determine and provide A-NSSAI that includes S-NSSAIs of a number of replacement network slices. More particularly, when UE 102 sends the registration request, AMF 402 may obtain the R-NSSAI from the registration request and obtain C-NSSAI and a list of replacement/alternate network slices (for each S-NSSAI in the C-NSSAI) from UDM 404. After obtaining the R-NSSAI, the C-NSSAI, and the list of replacement network slices, AMF 402 may determine the A-NSSAI in different ways, depending on whether NSSF 406 is deployed in core network 206.

If NSSF 406 is not deployed in core network 206, then AMF 402 may determine, for each S-NSSAI in the C-NSSAI and/or R-NSSAI, whether the slice designated by the S-NSSAI is unavailable or congested (e.g., consult an Operation Administration and Maintenance (OAM) system or a Network Data Analytics Function (NWDAF); or subscribe to the NWDAF). If AMF 402 determines that the network slice is available, AMF 402 may place the S-NSSAI of the slice in a candidate list of S-NSSAIs for A-NSSAI. If the network slice is not available for use, AMF 402 may check the list of replacement network slices for their availability. If the replacement network slices are available for use, AMF 302 may add the S-NSSAIs of the replacement network slices to the candidate list of S-NSSAIs for A-NSSAI. By checking the C-NSSAI, the R-NSSAI, and the list of the replacement network slices in the preceding manner, AMF 402 may generate the list of candidate S-NSSAIs for A-NSSAI. AMF 402 may trim the list of candidate S-NSSAIs to obtain the A-NSSAI.

If NSSF 406 is deployed in core network 206, AMF 402 may request NSSF 406 for an A-NSSAI, passing the C-NSSAI, the R-NSSAI, and the list of replacement network slices for UE 102 along with the request to NSSF 406. In response, NSSF 406 may determine, for each S-NSSAI in the C-NSSAI and/or R-NSSAI, whether the slice designated by the S-NSSAI is unavailable/congested. If NSSF 406 determines that the network slice is available, NSSF 406 may place the S-NSSAI of the slice in a candidate list of S-NSSAIs for A-NSSAI. If the network slice is not available for use, NSSF 406 may check the list of replacement network slices for their availability. If the replacement network slices are available for use, NSSF 406 may add the S-NSSAIs of the replacement network slices to the candidate list of S-NSSAIs for A-NSSAI. By checking the C-NSSAI, the R-NSSAI, and the list of the replacement network slices in the preceding manner, NSSF 406 may generate the list of candidate S-NSSAIs for A-NSSAI. NSSF 406 may trim the list of candidate S-NSSAIs to obtain the A-NSSAI and send the A-NSSAI to AMF 402. AMF 402 may provide the A-NSSAI in a registration accept message that AMF 402 sends to UE 102.

When AMF 402 receives a request from UE 102 to establish a session with a network slice, AMF 402 may determine whether the network slice identified by the S-NSSAI in the session request is available or is congested. If AMF 402 determines (e.g., by using an OAM, an NWDAF, or NSSF 406) that the network slice is available, AMF 402 may have a session management function (SMF) (not shown) set up the session with the network slice designated by the S-NSSAI. However, if the network slice is not available or congested, AMF 402 may look up replacement network slices (i.e., find replacement NSSAIs) and have UE 102 connect to one of the replacement network slices.

UDM 404, as indicated above, may refer to a combination of a UDM and a UDR. UDM 404 may maintain subscription data for UEs 102, manage subscriptions, generate authentication credentials, handle user identification, perform access authorization based on subscription data, perform network function registration management, maintain service and/or session continuity by maintaining assignment of the SMF for ongoing sessions, support SMS delivery, support lawful intercept functionality, and/or perform other processes associated with managing user data. The UDR part of UDM 404 may store information that the UDM manages. The subscription data that UDM 404 manages/stores may include a list of subscribed network slices (i.e., NSSAI for the subscribed network slices-C-NSSAI) and for each of the subscribed S-NSSAIs, a list of replacement or alternate S-NSSAIs.

In some implementations, UDM 404 may store a list of subscribed network slices and replacement network slices. When the user of UE 102 subscribes to a network slice at network 104, network 104 may offer the user an option to select one or more replacement network slices. Thus, if a user subscribes to network slice A for a gaming service with a medium level QoS, the user may be offered an opportunity to select a network slice B with a lower level QoS or a network slice C with a higher level QoS. Network 104 may charge the user higher rates for using network slice C as a replacement network slice, depending on the implementation.

In some implementations, the user may be offered a “no replacement” option when electing replacement network slices. Later, if the subscribed network slice becomes unavailable and the user has selected the no replacement option (i.e., has not specified a replacement network slice), network 104 may not permit UE 102 to connect to a network slice. The user may select the “no replacement” option, for example, if all replacement or alternate slices require a higher rate of charge or if network 104 does not support any replacement or alternate network slices in the coverage area.

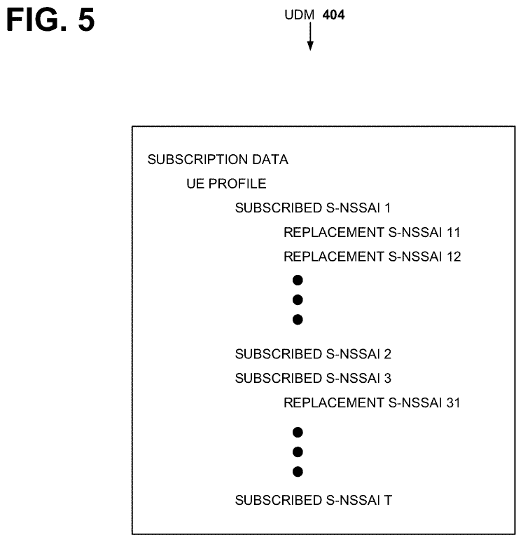

FIG. 5 illustrates example replacement NSSAIs stored at the UDR portion of UDM 404, according to an implementation. As shown, the UDR may include subscription data, which in turn may include one or more of UE profile. The UE profile may include a series of subscribed S-NSSAIs (e.g., in FIG. 5, S-NSSAI 1, S-NSSAI 2 . . . S-NSSAI T, where the maximum possible value of T is 16, for example). Under each subscribed S-NSSAI, there may be a list of replacement or alternate S-NSSAIs (e.g., in FIG. 5, replacement S-NSSAI 11, replacement S-NSSAI 12 . . . for subscribed S-NSSAI 1). Given a subscribed NSSAI, the order in which its replacement NSSAIs are listed may indicate the relative priorities of the corresponding replacement network slices. For example, if the network slice identified by the subscribed NSSAI 1 becomes unavailable to provide services to UE 102, the system for selecting and using replacement network slices may determine whether to use the replacement network slice with the replacement S-NSSAI 11 before considering other replacement network slices (e.g. replacement network slice 12). That is, the system may consider replacing the unavailable subscribed network slice with replacement network slices in the order in which they are listed as replacement slices under the S-NSSAI of the subscribed network slice, in the UE profile stored in the UDR.

Referring back to FIG. 4, NSSF 406 may select a set of network slice instances to serve a particular UE 102, determine NSSAI; identify a particular AMF 402 to serve a particular UE 102; and/or perform other types of processing associated with network slice selection or management. NSSF 406 may determine whether one or more network slices corresponding to S-NSSAIs (in NSSAI) are available to provide services or are congested. NSSF 406 may compile the list of S-NSSAIs that identify available network slices into a list of allowed network slices (e.g., A-NSSA) and provide the list to a service consumer function/component.

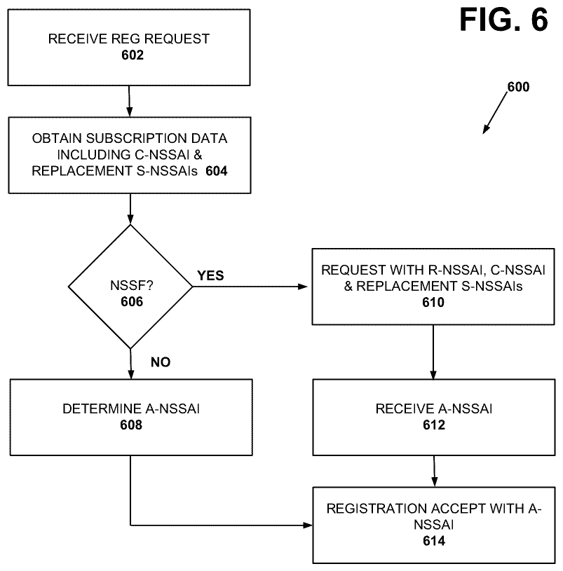

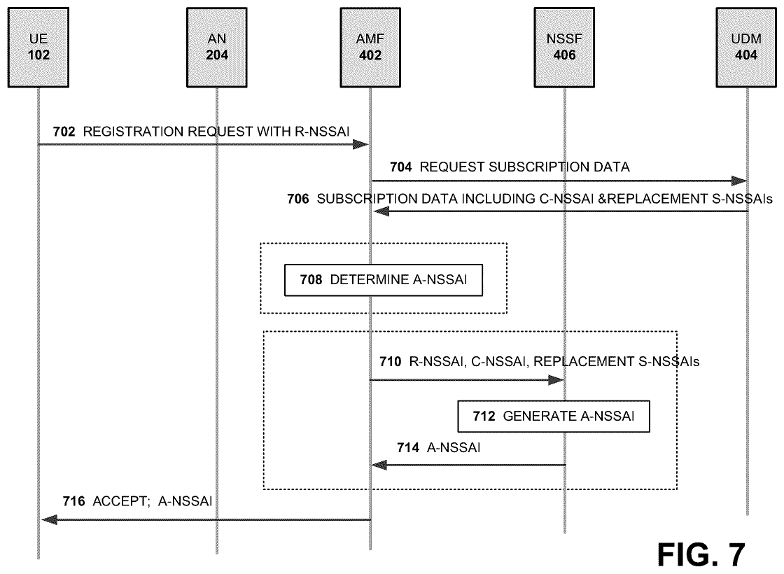

FIG. 6 is a flow diagram of an exemplary process 600 for selecting and using replacement network slices, according to an implementation. FIG. 7 is a messaging diagram which is associated with process 600 and is described below in connection with FIG. 6. Process 600 may be performed by one or more components and devices of the system for selecting and using replacement network slices, some of which are shown in FIG. 7. As shown in FIG. 6, process 600 may include AMF 402 receiving a registration request from UE 102 (block 602; arrow 702). The registration request may include R-NSSAI (requested NSSAI). In response to the receipt, AMF 402 may send a request for subscription data to UDM 404 and obtain subscription data from UDM 404 (block 604; arrows 704 and 706). The subscription data may include subscribed NSSAI (C-NSSAI) and replacement (or alternate). Process 600 may then proceed to block 606, where it is determined whether NSSF 406 is deployed in network 104 (or core network 206).

If NSSF 406 is not deployed in network 104 (block 606: NO), then AMF 402 may determine an A-NSSAI (block 608; block 708). More specifically, AMF 402 may determine, for each S-NSSAI in the C-NSSAI and/or R-NSSAI, whether the slice designated by the S-NSSAI is unavailable or congested (e.g., consult an Operation Administration and Maintenance (OAM) system or NWDAF; or subscribe to the NWDAF). If AMF 402 determines that the network slice is available, AMF 402 may place the S-NSSAI of the slice in a candidate list of S-NSSAIs for A-NSSAI. If the network slice is not available for use, AMF 402 may check the list of replacement network slices for their availability. If the replacement network slices are available for use, AMF 302 may add the S-NSSAIs of the replacement network slices to the candidate list of S-NSSAIs for A-NSSAI. By checking the C-NSSAI, the R-NSSAI, and the list of the replacement network slices in the preceding manner, AMF 402 may generate the list of candidate S-NSSAIs for A-NSSAI. AMF 402 may trim the list of candidate S-NSSAIs to obtain the A-NSSAI.

If NSSF 406 is deployed in network 104 (block 606: YES), AMF 402 may request NSSF 406 for A-NSSAI, passing the R-NSSAI, the C-NSSAI, and the list of replacement network slices for UE 102 with the request to NSSF 406 (block 610; arrow 710). In response, NSSF 406 may determine, for each S-NSSAI in the C-NSSAI and/or R-NSSAI, whether the slice designated by the S-NSSAI is unavailable/congested. If NSSF 406 determines that the network slice is available, NSSF 406 may place the S-NSSAI of the slice in a candidate list of S-NSSAIs for A-NSSAI. If the network slice is not available for use, NSSF 406 may check the list of replacement network slices for their availability. If the replacement network slices are available for use, NSSF 406 may add the S-NSSAIs of the replacement network slices to the candidate list of S-NSSAIs for A-NSSAI. By checking the C-NSSAI, the R-NSSAI, and the list of the replacement network slices in the preceding manner, NSSF 406 may generate the list of candidate S-NSSAIs for A-NSSAI. NSSF 406 may trim the list of candidate S-NSSAIs to generate the A-NSSAI (block 712) and pass the A-NSSAI to AMF 402 (arrow 714). AMF 402 may receive the A-NSSAI from NSSF 406 (block 612; arrow 714). AMF 402 may then send a registration accept message with the A-NSSAI to UE 102 (block 614; arrow 716).

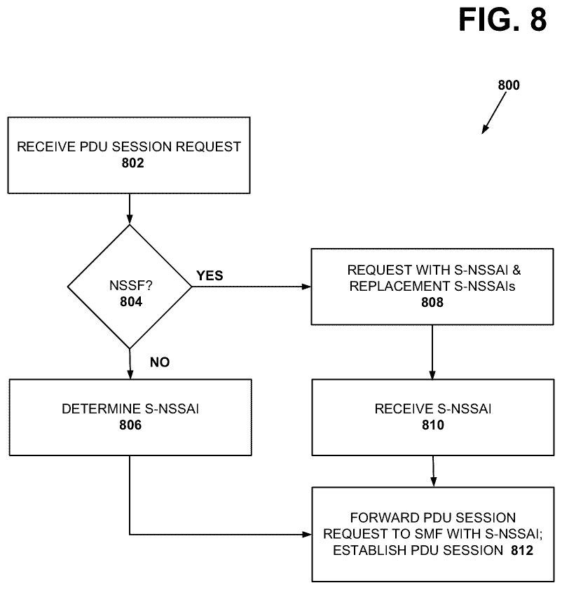

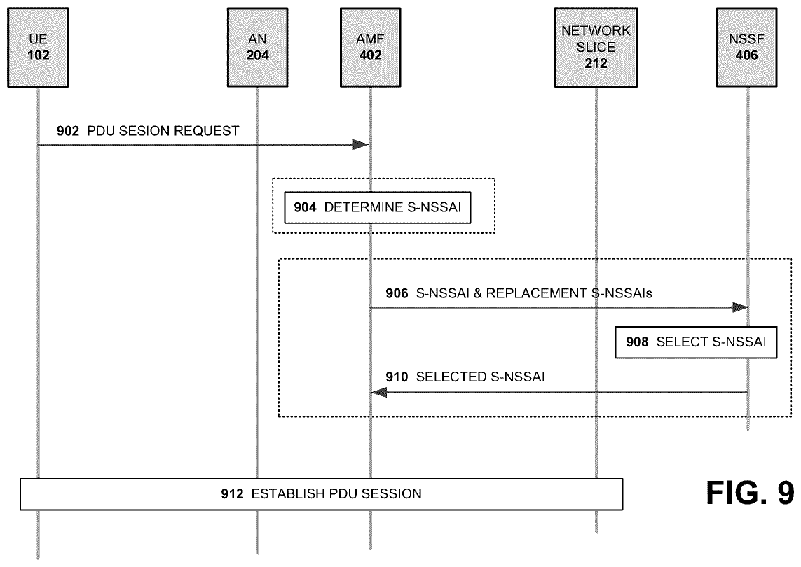

FIG. 8 is a flow diagram of an exemplary process 800 for selecting and using replacement network slices, according to another implementation. FIG. 9 is a messaging diagram which is associated with process 800 and is described below in connection with FIG. 8. Process 800 may be performed by one or more components and devices of the system for selecting and using replacement network slices, some of which are shown in FIG. 9. As shown in FIG. 8, process 800 may include AMF 402 receiving a PDU session request from UE 102 (block 802; arrow 902). The request may specify S-NSSAI that identifies a network slice with which UE 102 wishes to establish the PDU session. Process 800 may then proceed to block 804, where it is determined whether NSSF 406 is deployed in network 104 (or core network 206).

If NSSF 406 is not deployed in network 104 (block 804: NO), then AMF 402 may determine an S-NSSAI with which UE 102 is to establish the PDU session (block 806; block 904). More specifically, AMF 402 may determine whether the network slice identified by the S-NSSAI received in the PDU request is available or uncongested. If the network slice is available or uncongested, AMF 402 may select the network slice and the S-NSSAI for use by UE 102. However, if AMF 402 determines that the network slice is not available or congested, AMF 402 may check corresponding replacement network slices for their availability. The identities of the replacement network slices may be obtained from a cached list of replacement network slices (e.g., cached during the registration) or obtained by querying UDM 404 for the list of replacement network slices for UE 102. AMF 402 may then select one of the available replacement network slices for use by UE 102. That is, AMF 402 may select either the S-NSSAI sent by UE 102 or one of the replacement S-NSSAIs as the S-NSSAI of an available network slice to which UE 102 is to establish the PDU session.

If NSSF 406 is deployed in core network 206 (block 804: YES), AMF 402 may send a request to identify an available network slice to NSSF 406, passing to NSSF 406 the S-NSSAI in the PDU session request and the corresponding replacement NSSAIs (e.g., replacement NSSAI obtained from UDM 404 or from cached S-NSSAIs during an earlier UE registration) (block 808; arrow 906). NSSF 406 may then determine whether the network slice identified by the S-NSSAI is available. If the network slice is available, NSSF 406 may select the S-NSSAI to pass to AMF 402. If the network slice designated by the S-NSSAI is not available, NSSF 406 may select the S-NSSAI of one of the list of replacement network slices. In either case, NSSF 406 may select the S-NSSAI of an available network slice (block 908). NSSF 406 may then send the selected S-NSSAI to AMF 402 (arrow 910). AMF 402 may receive the S-NSSAI from NSSF 406 (block 810; arrow 910) then pass the session establishment request to the SMF, along with the S-NSSAI to establish the session (block 812; block 912).

FIG. 10 depicts exemplary components of an exemplary network device 1000. Network device 1000 may correspond to or be included in any of the devices and/or components illustrated in FIGS. 1-4, 6, and 8 (e.g., UE 102, access network 204, core network 206, data network 208, access station 210, AMF 402, UDM 404, NSSF 406, etc.). In some implementations, network devices 1000 may be part of a hardware network layer on top of which other network layers and network functions (NFs) may be implemented.

As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 10. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.). Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., a transmitter and a receiver) for network device 1000 to communicate with other devices and/or systems. For example, via network interface 1010, network device 1000 may communicate over a network, such as the Internet, an intranet, cellular, a terrestrial wireless network, a satellite-based network, optical network, etc. Network interface 1010 may include a modem, an Ethernet interface to a LAN, and/or an interface/connection for connecting network device 1000 to other devices.

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 6-9, the order of the actions, messages, signals may be modified in other implementations. In addition, non-dependent actions, messages, and signals may represent actions, messages, and signals that can be performed, sent, and/or received in parallel and in different orders. Furthermore, each actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive, from the User Equipment device (UE), over a network, a registration request that identifies network slices requested by the UE;
request a network component to provide a list of network slices to which the UE is subscribed;
obtain a list of replacement network slices for replacing one or more of the list of network slices when one or more of the list of network slices become unavailable for a session with the UE;
obtain a second list of network slices, which are allowed by the network to establish a session with the UE, based on the list of network slices and the list of replacement network slices; and
send the second list of network slices to the UE.

2. The device of claim 1, wherein when obtaining the list of replacement network slices, the processor is configured to:
request subscription data from a Unified Data Management (UDM); and
receive the list of replacement network slices from the UDM.

3. The device of claim 2, wherein the UDM includes a Unified Data Repository (UDR), wherein the UDR includes a subscription profile for the UE, and wherein the subscription profile includes:
the list of network slices; and
for each network slice identified by the list of network slices, a third list of identifiers for a set of replacement network slices, wherein an order of the identifiers in the third list indicates relative priorities of the set of replacement network slices.

4. The device of claim 1, wherein when obtaining the second list of network slices based on the list of network slices and the list of replacement network slices, the processor is configured to:
determine whether one or more network slices identified by the list are available for establishing a session with the UE or are congested.

5. The device of claim 1, wherein when obtaining the second list of network slices based on the list of network slices and the list of replacement network slices, the processor is configured to:
select one or more network slices, which are available for establishing a session with the UE, from the list of network slices and the list of replacement network slices.

6. The device of claim 1, wherein when obtaining the second list of network slices based on the list of network slices and the list of replacement network slices, the processor is configured to:
send a request to a Network Slice Selection Function (NSSF) to provide the second list of network slices, wherein the request includes the list of network slices and the list of replacement network slices; and
receive the second list of network slices from the NSSF.

7. The device of claim 6, wherein the NSSF is configured to:
select one or more Single-Network Slice Selection Assistance Information (S-NSSAIs) from the list of network slices and the list of replacement network slices, and wherein the selected one or more S-NSSAIs identify network slices that are available to establish a session with the UE.

8. The device of claim 1, wherein the processor is further configured to:
receive a request from the UE to establish a Protocol Data Unit (PDU) session with a network slice identified by a first Single-Network Slice Selection Assistance Information (S-NSSAI);
identify a network slice with which the UE is to establish the PDU session based on the first S-NSSAI; and
send a message to a Session Management Function (SMF) to establish the PDU session between the identified network slice and the UE.

9. The device of claim 8, wherein when identifying the network slice, the processor is configured to:
send a slice request, to a Network Slice Selection Function (NSSF), to provide a second S-NSSAI of the network slice with which the UE is to establish the PDU session; and
receive the second S-NSSAI from the NSSF.

10. The device of claim 1, wherein the device includes an Access and Mobility Management Function (AMF), wherein when sending the third list of network slices, the processor is configured to:
send a registration accept message to the UE.

11. A method comprising:
receiving, by a device from the User Equipment device (UE), over a network, a registration request that identifies a list of network slices requested by the UE;
requesting a network component to provide a list of network slices to which the UE is subscribed;
obtaining a list of replacement network slices for replacing one or more of the list of network slices when one or more of the list of network slices become unavailable for a session with the UE;
obtaining a second list of network slices, which are allowed by the network to establish a session with the UE, based on the list of network slices and the list of replacement network slices; and
sending the second list of network slices to the UE.

12. The method of claim 11, wherein obtaining the list of replacement network slices includes:
requesting subscription data from a Unified Data Management (UDM); and
receiving the list of replacement network slices from the UDM.

13. The method of claim 12, wherein the UDM includes a Unified Data Repository (UDR), wherein the UDR includes a subscription profile for the UE, and wherein the subscription profile includes:
the list of network slices; and
for each network slice identified by the list of network slices, a third list of identifiers for a set of replacement network slices, wherein an order of the identifiers in the third list indicates relative priorities of the set of replacement network slices.

14. The method of claim 11, wherein obtaining the second list of network slices based on the list of network slices and the list of replacement network slices includes:
determining whether one or more network slices identified by the list are available for establishing a session with the UE or are congested.

15. The method of claim 11, wherein obtaining the second list of network slices based on the list of network slices and the list of replacement network slices includes:
selecting one or more network slices, which are available for establishing a session with the UE, from the list of network slices and the list of replacement network slices.

16. The method of claim 11, wherein obtaining the second list of network slices based on the list of network slices and the list of replacement network slices includes:
sending a request to a Network Slice Selection Function (NSSF) to provide the second list of network slices, wherein the request includes the list of network slices and the list of replacement network slices; and
receiving the second list of network slices from the NSSF.

17. The method of claim 16, further comprising:
selecting, by the NSSF, one or more Single-Network Slice Selection Assistance Information (S-NSSAIs) from the list of network slices and the list of replacement network slices, and wherein the selected one or more S-NSSAIs identify network slices that are available to establish a session with the UE.

18. The method of claim 11, further comprising:
receiving a request from the UE to establish a Protocol Data Unit (PDU) session with a network slice identified by a first Single-Network Slice Selection Assistance Information (S-NSSAI);
identifying a network slice with which the UE is to establish the PDU session based on the first S-NSSAI; and
sending a message to a Session Management Function (SMF) to establish the PDU session between the identified network slice and the UE.

19. The method of claim 18, wherein identifying the network slice includes:
sending a slice request, to a Network Slice Selection Function (NSSF), to provide a second S-NSSAI of the network slice with which the UE is to establish the PDU session; and
receiving the second S-NSSAI from the NSSF.

20. A non-transitory computer-readable medium comprising processor-executable instructions, which when executed by one or more processors, cause the one or more processors to:
receive, from the User Equipment device (UE), over a network, a registration request that includes a list of network slices requested by the UE;
request a network component to provide a list of network slices to which the UE is subscribed;
obtain a list of replacement network slices for replacing one or more of the list of network slices when one or more of the list of network slices become unavailable for a session with the UE;
obtain a second list of network slices, which are allowed by the network to establish a session with the UE, based on the list of network slices and the list of replacement network slices; and
send the second list of network slices to the UE.
